(19) United States
(12) Patent Application Publication
(10) Pub. No.: US 2021/0181521 A1
(43) Pub. Date: Jun. 17, 2021

(54) NEAR FIELD LINE PATTERN GENERATOR

(71) Applicant: Lumileds Holding B.V., Schiphol (NL)

(72) Inventors: Charles Schrama, San Jose, CA (US); Mehdi Aas, Eindhoven (NL)

(73) Assignee: Lumileds Holding B.V., Schiphol (NL)

(21) Appl. No.: 16/713,701

(22) Filed: Dec. 13, 2019

(51) Int. Cl. G02B 27/42; G01B 11/14

(52) U.S. Cl. CPC G02B 27/4272; G01B 11/14; G02B 27/4205

(57) ABSTRACT

A near field line pattern generator includes a double grating and at least one light emitting diode (LED). The double grating includes a first grating and a second grating, each having alternating light blocking sections and light transmitting sections. The LED emits light directed at the double grating assembly such that a first portion of light passes through the first grating, and a second portion of the light passed through the first grating passes through the second grating. The light passing through the second grating forms a line pattern at a focal distance from the double grating assembly. The line pattern has alternating bright portions and dark portions. In some aspects, the pitch of the second grating is less than the pitch of the first grating. In some aspects, the near field line pattern generator also includes a convergent lens for focusing the line pattern at the focal distance.

### TECHNICAL FIELD OF THE DISCLOSURE

The present disclosure relates generally to a line pattern generator and, more specifically, to an apparatus for generating a line pattern in the near field, e.g., at a distance of around 20 cm or less.

### BACKGROUND

Line pattern generators are used to illuminate objects in a target area with a pattern of light, e.g., visible or infrared light. Observation of an object illuminated with a pattern can be used to determine information about the object, e.g., the location or orientation of the object. Existing line pattern generators may use one or more light sources, such as light emitting diodes (LEDs), combined with a grating or other patterned mask, which blocks a portion of the light emitted from the light sources.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 provides a cross section of transmitted light passed through a prior art double grating;

FIG. 2 provides light intensity fields at several distances from a prior art double grating;

FIG. 3 provides a cross section of a line pattern generator having a dual-pitch double grating, according to some embodiments of the present disclosure;

FIG. 4 provides a cross section of a line pattern generator having a dual-pitch double grating focusing light along a target plane, according to some embodiments of the present disclosure;

FIG. 5 provides a cross section of a portion of a dual-pitch double grating, according to some embodiments of the present disclosure;

FIG. 6 provides a cross section of a light pattern generating having a double grating with a lens for focusing light along a target plane, according to some embodiments of the present disclosure;

FIG. 7A provides light intensity fields at several distances for a double grating line pattern generator focused 5 cm from the line pattern generator, according to some embodiments of the present disclosure;

FIG. 7B provides a close up of the light intensity field 5 cm from the double grating line pattern generator focused 5 cm from the line pattern generator, according to some embodiments of the present disclosure;

FIG. 8 provides light intensity fields at several distances for a double grating line pattern generator focused 10 cm from the line pattern generator, according to some embodiments of the present disclosure;

FIG. 9 provides light intensity fields at several distances for a double grating line pattern generator focused 20 cm from the line pattern generator, according to some embodiments of the present disclosure;

FIG. 10 provides a block diagram illustrating an example of a distance measurement system for measuring a distance to a target object, according to some embodiments of the present disclosure;

FIG. 11A provides an example of the line pattern generator of FIG. 10 generating a line pattern on a target object at a first distance from the line pattern generator, according to some embodiments of the present disclosure;

FIG. 11B provides an example of the line pattern generated on the target object in FIG. 11A, according to some embodiments of the present disclosure;

FIG. 11C provides an example of the line pattern generator of FIG. 10 generating a line pattern on a target object at a second distance from the line pattern generator, according to some embodiments of the present disclosure;

FIG. 11D provides an example of the line pattern generated on the target object in FIG. 11C, according to some embodiments of the present disclosure;

FIG. 12 provides a block diagram illustrating an example data processing system for use in the distance measurement system of FIG. 10, according to some embodiments of the present disclosure.

### DESCRIPTION OF EXAMPLE EMBODIMENTS OF THE DISCLOSURE

Overview

The systems, methods and devices of this disclosure each have several innovative aspects, no single one of which is solely responsible for the all of the desirable attributes disclosed herein. Details of one or more implementations of the subject matter described in this specification are set forth in the description below and the accompanying drawings.

For purposes of illustrating the near field line pattern generator described herein, it might be useful to understand phenomena that may come into play in a distance measurement system. The following foundational information may be viewed as a basis from which the present disclosure may be properly explained. Such information is offered for purposes of explanation only and, accordingly, should not be construed in any way to limit the broad scope of the present disclosure and its potential applications.

Structured light patterns can be projected into a target area to produce a light pattern across objects in the target area. Structured light patterns can be used to determine the location, orientation, size, and/or other features of one or more objects within the target area. For small form-factor applications, lasers with highly collimated light output can be used to produce structured light patterns. However, using lasers to produce structured light is both cost- and energy-intensive. As an alternative, line pattern generators that use an LED light source and one or more gratings have been developed. For example, in double grating line pattern generators, an LED light source projects light through two gratings of equal pitch, and the light that passes through both of the gratings forms a line pattern corresponding to the grating pattern across a target area. Existing double grating line pattern generators can produce a pattern of lines on a target object positioned at least a minimum distance from the line pattern generator (e.g., at least 30 cm from the line pattern generator). However, in prior double grating line pattern generators, the line pattern vanishes when the light is projected onto objects located a shorter distance away from the line pattern generator (e.g., 20 cm or less).

Embodiments of the present disclosure provide line pattern generators that can generate line patterns in a near field, e.g., less than 20 cm from the line pattern generator. In one aspect, a near field line generator includes a double grating assembly and at least one light emitting diode (LED). The double grating assembly includes a first grating and a second grating, each of which includes alternating light blocking sections and light transmitting sections. The at least one LED is configured to emit light in the direction of the double grating assembly. The first grating is positioned nearer to the at least one LED than the second grating, such that a first portion of the light emitted from the LED passes through the first grating, and a second portion of the light passed through the first grating passes through the second grating. In particular, the light blocking sections of the first and second grating block light emitted from the at least one LED, and the light transmitting sections of the first and second grating transmit light emitted from the at least one LED. The first and second gratings each have a respective pitch, which is consistent across each grating. As used herein, the “pitch” of a grating is the sum of the width of one light blocking section and one light transmitting section of the grating, i.e., the distance from a position on a light blocking section to the same position on a subsequent light blocking section. In this aspect, the pitch of the first grating is greater than the pitch of the second grating. The light that passes through the first grating and the second grating forms a line pattern at a particular focal distance from the double grating assembly. The line pattern has alternating “bright” portions and “dark” portions. As used herein, “bright” portions of a line pattern have an intensity above a threshold, and “dark” portions of a line pattern have an intensity below a threshold. For example, the bright portions have an intensity above 50% of a maximum intensity across the line pattern, and the dark portions have an intensity below 50% of the maximum intensity across the line pattern.

In another aspect, a near field line generator includes a double grating assembly, at least one light emitting diode (LED), and a convergent lens. The double grating assembly includes a first grating and a second grating, each of which includes alternating light blocking sections and light transmitting sections. The double grating assembly has a first focal distance. The at least one LED is configured to emit light in the direction of the double grating assembly. The first grating is positioned nearer to the at least one LED than the second grating, such that a first portion of the light emitted from the LED passes through the first grating, and a second portion of the light passed through the first grating passes through the second grating. In this aspect, the first grating and the second grating may have the same pitch. The convergent lens is configured to adjust the light passed through the second grating. Light that passes through the double grating assembly and the convergent lens forms a line pattern at a second focal distance from the double grating assembly. The line pattern has alternating bright portions and dark portions.

Embodiments disclosed herein may be particularly advantageous for generating line pattern in the near field of the line pattern generator, e.g., across objects or areas that are a relatively short distance (e.g., 30 cm or less) from the line pattern generator. The embodiments disclosed herein may generate a line pattern at a particular focal distance away from the line pattern generator, e.g., 5 cm away, 10 cm away, or 20 cm away from the line pattern generator. A line pattern generator focused at a particular target distance can be used in a system to identify whether objects are present in the near field at or around the target distance away from the line pattern generator. Other features and advantages of the disclosure will be apparent from the following description and the claims.

As will be appreciated by one skilled in the art, aspects of the present disclosure, in particular aspects of a near field line pattern generator, described herein, may be embodied in various manners—e.g. as a method, a system, a computer program product, or a computer readable storage medium. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing measurement systems or their controllers) or be stored upon manufacturing of these devices and systems.

In the following detailed description, various aspects of the illustrative implementations may be described using terms commonly employed by those skilled in the art to convey the substance of their work to others skilled in the art. For example, the term “connected” means a direct electrical or magnetic connection between the things that are connected, without any intermediary devices, while the term “coupled” means either a direct electrical or magnetic connection between the things that are connected, or an indirect connection through one or more passive or active intermediary devices. The term “circuit” means one or more passive and/or active components that are arranged to cooperate with one another to provide a desired function. The terms “substantially,” “close,” “approximately,” “near,” and “about,” generally refer to being within +/−20%, preferably within +/−10%, of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the context of a particular value as described herein or as known in the art.

The terms such as “over,” “under,” “between,” and “on” as used herein refer to a relative position of one material layer or component with respect to other layers or components. For example, one layer disposed over or under another layer may be directly in contact with the other layer or may have one or more intervening layers. Moreover, one layer disposed between two layers may be directly in contact with one or both of the two layers or may have one or more intervening layers. In contrast, a first layer described to be “on” a second layer refers to a layer that is in direct contact with that second layer. Similarly, unless explicitly stated otherwise, one feature disposed between two features may be in direct contact with the adjacent features or may have one or more intervening layers.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges. As used herein, the notation “A/B/C” means (A), (B), and/or (C).

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. The disclosure may use perspective-based descriptions such as “above,” “below,” “top,” “bottom,” and “side”; such descriptions are used to facilitate the discussion and are not intended to restrict the application of disclosed embodiments. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

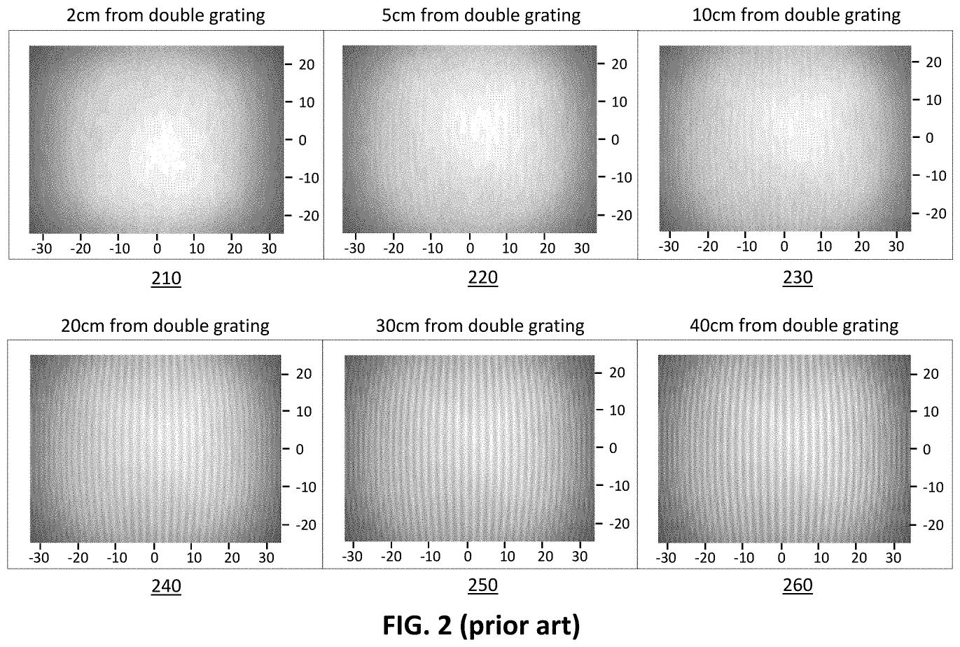

In the following detailed description, reference is made to the accompanying drawings that form a part hereof, showing, by way of illustration, some of the embodiments that may be practiced. In the drawings, same reference numerals refer to the same or analogous elements/materials so that, unless stated otherwise, explanations of an element/material with a given reference numeral provided in context of one of the drawings are applicable to other drawings where elements/materials with the same reference numerals may be illustrated. For convenience, if a collection of drawings designated with different letters are present, e.g., FIGS. 2A-2C, such a collection may be referred to herein without the letters, e.g., as “FIG. 2.” The accompanying drawings are not necessarily drawn to scale. Moreover, it will be understood that certain embodiments can include more elements than illustrated in a drawing, certain embodiments can include a subset of the elements illustrated in a drawing, and certain embodiments can incorporate any suitable combination of features from two or more drawings.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

In some examples provided herein, interaction may be described in terms of two, three, four, or more electrical components. However, this has been done for purposes of clarity and example only. It should be appreciated that the devices and systems described herein can be consolidated in any suitable manner. Along similar design alternatives, any of the illustrated components, modules, and elements of the accompanying drawings may be combined in various possible configurations, all of which are clearly within the broad scope of the present disclosure. In certain cases, it may be easier to describe one or more of the functionalities of a given set of flows by only referencing a limited number of electrical elements.

The following detailed description presents various descriptions of specific certain embodiments. However, is to be understood that other embodiments may be utilized, and structural or logical changes may be made without departing from the scope of the present disclosure. In general, the innovations described herein can be embodied in a multitude of different ways, for example, as defined and covered by the claims and/or select examples, and the following detailed description is not to be taken in a limiting sense.

### Example Prior Art Double Grating

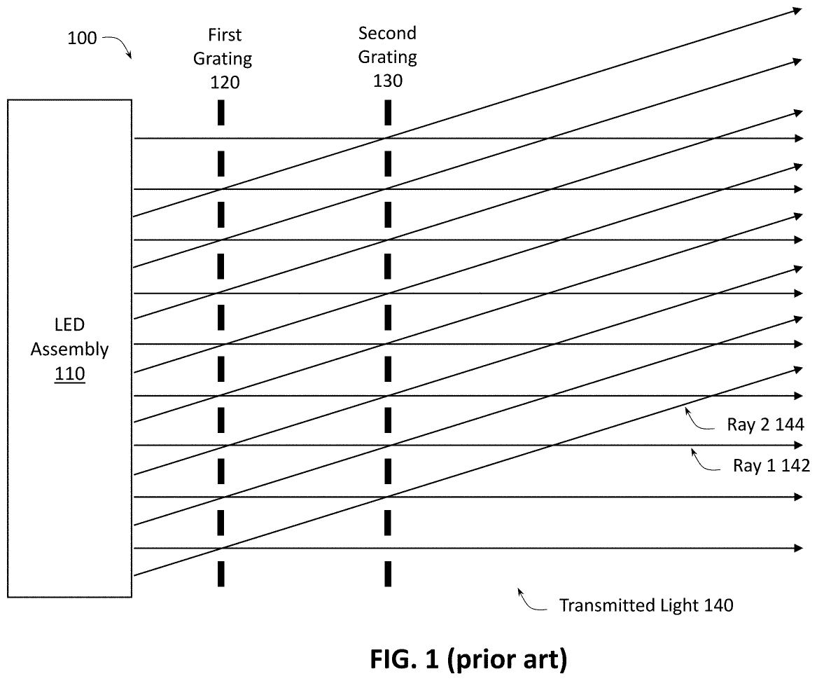

FIG. 1 provides a cross section of transmitted light passed through a prior art double grating. A light emitting diode (LED) assembly 110 emits light in the general direction of a double grating that includes a first grating 120 and second grating 130. The LED assembly 110 emits light rays at multiple angles and from multiple positions, as shown in FIG. 1. For example, the LED assembly 110 may be a collection of LEDs, each of which emits light rays at multiple angles. Two angles of light rays emitted by the LED assembly 110 are shown in FIG. 1; it should be understood that additional light rays at additional angles may also be emitted from the LED assembly 110.

The first grating 120 has a regular sequence of light transmitting sections and light blocking sections. The light transmitting sections and the light blocking sections are arranged at a first pitch. The second grating 130 is identical to the first grating 120, having the same pitch as the first grating 120. The second grating 130 is spaced some distance away from the first grating 120, e.g., 1 mm away from the first grating 120. The light transmitting sections and light blocking sections of the first grating 120 and the second grating 130 are aligned, such that light emitted perpendicular (or nearly perpendicular) to the gratings (e.g., ray 1 142) can be transmitted straight through a light transmitting portion of the first grating 120 and a corresponding light transmitting portion of the second grating 130. Light emitted at an angle not perpendicular to the gratings (e.g., ray 2 144) may be passed through one light transmitting portion of the first grating 120 and an offset light transmitting portion of the second grating 130.

FIG. 2 provides light intensity fields at several distances from the example prior art double grating shown in FIG. 1. In this example, the light intensity field 210 observed at 2 cm from the double grating does not have a discernable line pattern. The light intensity fields 220 and 230 observed at 5 cm and 10 cm, respectively, from the double grating have faint line patterns, but the lines are not crisp, and may not be suitable for distance measurement or other analysis of objects in target area at these distances. As shown in FIG. 1, the transmitted light 140 passing through the gratings 120 and 130 overlaps in front of the double grating in the near field, which causes the line patterns in the near field (e.g., less than 20 cm) to vanish, as shown in light intensity fields 210, 220, and 230.

The light intensity field 240 observed at 20 cm from the double grating has a stronger line pattern. The light intensity fields 250 and 260 observed at 30 cm and 40 cm, respectively, from the double grating have crisper line patterns still. The light intensity fields shown in FIG. 2 indicate that while the line pattern generator shown in FIG. 1 produces a discernable line pattern at a distance at least 20 cm from the double grating, the line pattern vanishes in the near field, e.g., below 20 cm from the double grating. The distance at which the line pattern vanishes for the aligned double grating can vary based on the geometry of the double grating arrangement, e.g., the pitch of the gratings, the distance between the gratings, the distance from the LED assembly to the gratings, etc. For example, in other arrangements, the line pattern may vanish at a distance 15 cm from the double grating, or 30 cm from the double grating.

### Example Line Pattern Generator with Dual-Pitch Double Grating

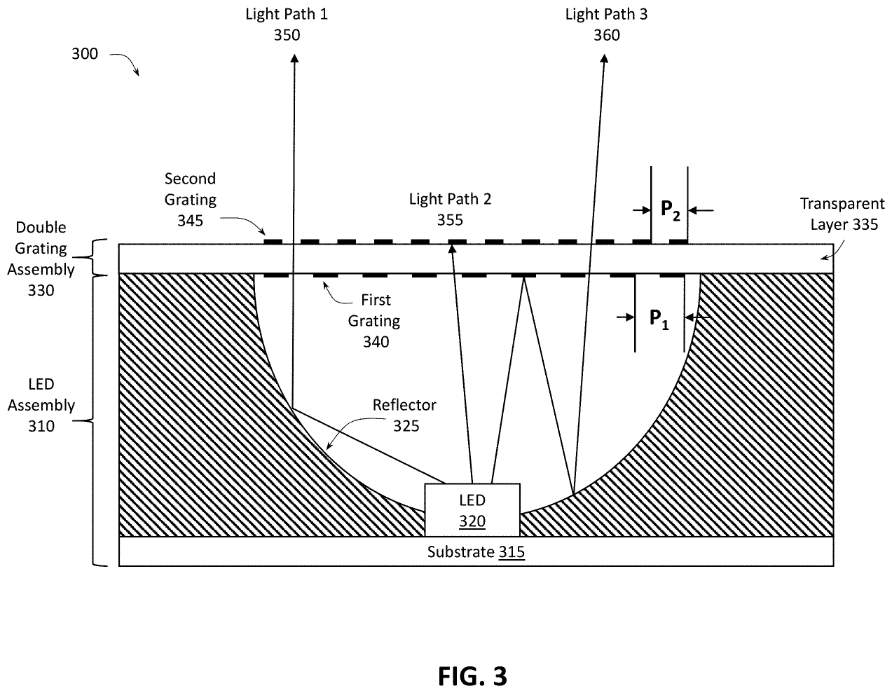

FIG. 3 provides a cross section of a line pattern generator 300 having a dual-pitch double grating according to some embodiments of the present disclosure. The line pattern generator 300 includes an LED assembly 310 and a double grating assembly 330. The LED assembly 310 includes at least one LED (e.g., LED 320) configured to emit light in the direction of the double grating assembly 330. The LED assembly 310 includes a substrate 315, an LED 320, and a reflector 325. The substrate 315 forms a base surface for the line pattern generator 300. The substrate 315 may be an insulator such as sapphire or a semiconductor such as gallium nitride (GaN). An LED 320 is formed on the substrate 315. The LED 320 is a device for emitting light at a given wavelength, e.g., a wavelength in the visible range (e.g., 400 to 740 nm), near infrared range (e.g., 0.75 to 1.4 μm), infrared range (1.4 to 15 μm), or ultraviolet range (e.g., 10 nm to 400 nm). In some embodiments, the LED 320 is configured to emit light in multiple wavelengths. The substrate 315 may include or be connected to a printed circuit board (PCB) for controlling and powering the LED 320.

The LED assembly 310 includes a reflector 325 configured to reflect light in a direction away from the LED assembly 310. The reflector 325 is positioned atop the substrate 315 and around the LED 320. The reflector 325 reflects light directly emitted by the LED 320 (e.g., light path 350) and reflects light that had been previously reflected back towards the LED assembly 310 (e.g., light path 360). The reflector 325 may be shaped to focus the light emitted from the LED 320 and enhance its brightness by maximizing the amount of light directed perpendicular, or roughly perpendicular, to the plane of the substrate 315. The reflector 325 is surrounded by side walls of the LED assembly 310, which are coated in a reflective material, e.g., silicone with TiOₓ particles.

In some embodiments, the LED assembly 310 comprises a plurality of LEDs 320, each having a respective reflector 325. The LEDs may be packaged with a minimal distance between adjacent LEDs, so that a consistent line pattern is produced across the LED assembly 310.

The double grating assembly 330 includes a transparent layer 335, a first grating 340, and a second grating 345. The first grating 340 and second grating 345 (collectively referred to as gratings 340 and 345) are formed on opposite sides of the transparent layer 335. The transparent layer 335 is an optically transparent material, such as glass, or a material that is transmits the wavelength emitted by the LED 320 (e.g., if the LED 320 emits infrared light, the transparent layer may be gallium arsenide (GaAs), which is not optically transparent but is transparent to infrared light). The first grating 340 and/or the second grating 345 may be deposited on opposite sides the transparent layer 335 using a deposition process. Alternatively, the first grating 340 and/or the second grating 345 may be independently formed (e.g., as metal masks) and layered with the transparent layer 335 to form the double grating assembly. In still other examples, the transparent layer 335 may be air or a vacuum. The first grating 340 and the second grating 345 may be formed of reflective materials, so that the light blocking sections of the gratings 340 and 345 reflect light back towards the LED assembly 310.

A cross section of the gratings 340 and 345 are shown in FIG. 3. Each of the gratings 340 and 345 has a series of parallel light blocking sections, represented by the dark lines in FIG. 3. The light blocking sections are separated by light transmitting sections. The light blocking sections and light transmitting sections of the first grating 340 are arranged at a first pitch, labelled P₁ in FIG. 3. The light blocking sections and light transmitting sections of the second grating 345 are arranged at a second pitch, labelled P₂ in FIG. 3. The first pitch P₁ is greater than the second pitch P₂.

Several example light paths are shown in FIG. 3. A portion of the light emitted by the LED 320 passes from the LED 320 and through the first grating 340. For example, light traveling along light path 2 355 passes directly from the LED 320 and through a light transmitting section of the first grating 340. Light traveling along path 1 350 is reflected by the reflector 325, and then passes through a light transmitting section of the first grating 340. Light traveling along light path 3 360 is reflected by a light blocking portion of the first grating 340, and does not pass through the first grating 340 until after it has been reflected again by the reflector 325. A portion of the light that passed through the first grating 340 passes through the second grating 345. Light traveling along light paths 350 and 360 pass through light transmitting sections of the second grating 345 after traveling through the first grating 340. Light traveling along light path 2 355 is blocked by a light blocking portion of the second grating 345. The second grating 345 may reflect the blocked light back towards the LED assembly 310.

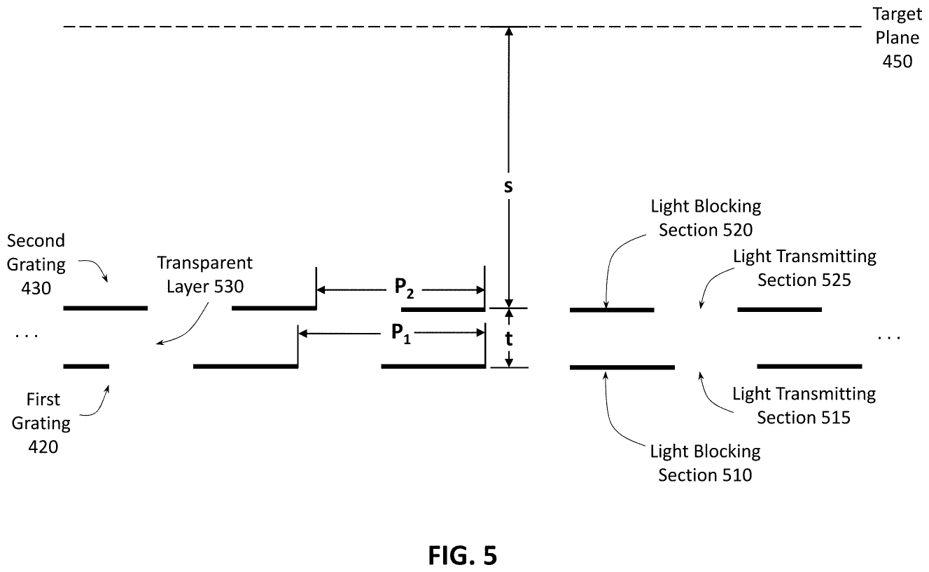

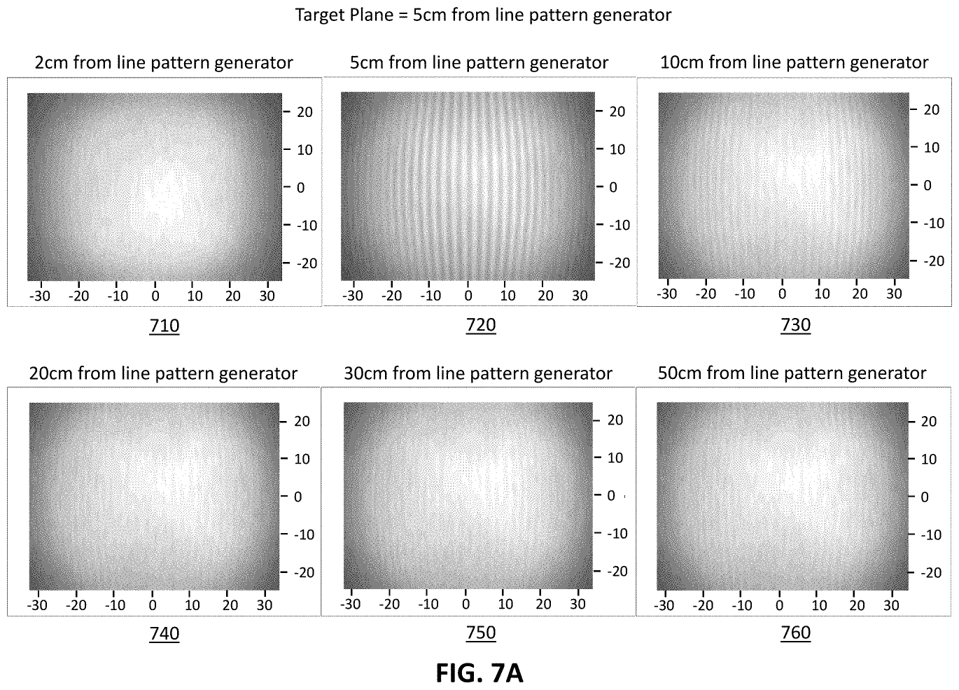

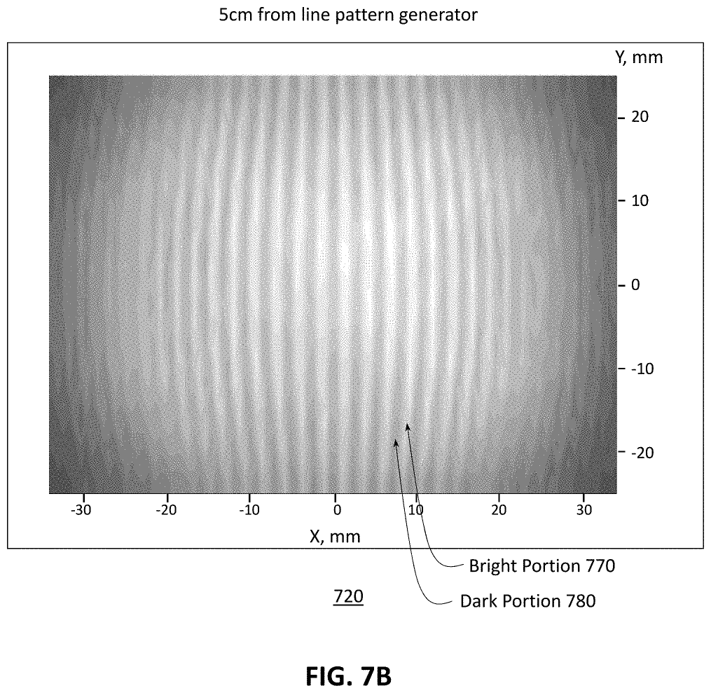

The light that passes through both the first grating and the second grating forms a line pattern with alternating bright portions and dark portions at a particular focal distance from the double grating assembly 330. Example line patterns at different focal distances are shown in FIGS. 7-10. A relationship between the focal distance and the pitches of the first grating 340 and the second grating 345 is described with respect to FIG. 5.

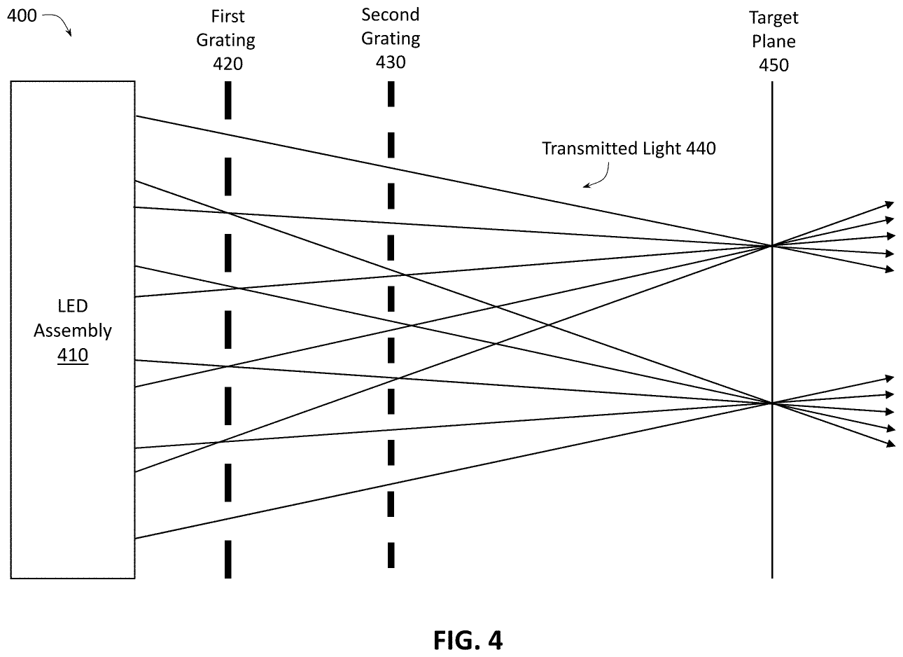

FIG. 4 provides a cross section of a line pattern generator 400 having a dual-pitch double grating focusing light along a target plane, according to some embodiments of the present disclosure. The line pattern generator 400 includes an LED assembly 410, a first grating 420, and a second grating 430. The first grating 420 and second grating 430 collectively form a dual-pitch double grating. The LED assembly 410, first grating 420, and second grating 430 may be similar to the LED assembly 310, first grating 340, and second grating 345 shown in FIG. 3. Alternatively, other arrangements may be used; for example, as shown in FIG. 4, there is a gap between the LED assembly 410 and the first grating 420.

FIG. 4 shows multiple paths of transmitted light 440 that pass through the both first grating 420 and the second grating 430. The LED assembly 410 emits light at various angles, some of which are shown in FIG. 4. The first grating 420 and second grating 430 selectively block the emitted light such that rays of the transmitted light 440 are focused at particular lines along a target plane 450. Cross sections of two such focal lines are shown in FIG. 4. The rays of transmitted light 440 shown in FIG. 4 overlap at two points in the cross section shown in FIG. 4. These points may be the maxima of the bright portions of the line pattern created by the line pattern generator 400. The rays of transmitted light 440 shown in FIG. 4 are a subset of the transmitted light paths. Examples of full line patterns are shown in FIGS. 7-10.

FIG. 5 provides a cross section of a portion of the dual-pitch double grating shown in FIG. 4, according to some embodiments of the present disclosure. The first grating 420 includes a series of alternating light blocking sections 510 and light transmitting sections 515. The second grating 430 includes a series of alternating light blocking sections 520 and light transmitting sections 525. The light blocking sections 510 and light transmitting sections 515 of the first grating 420 are arranged at a first pitch, labelled N. The light blocking sections 520 and light transmitting sections 525 of the second grating 430 are arranged at a second pitch, labelled P₂. The second grating 430 is a distance s from the target plane 450. A transparent layer 530 separates the first grating 420 and the second grating 430. The first grating 420 and the second grating 430 are separated by a distance labelled t, which is the thickness of the transparent layer 530. The material (or materials) of the transparent layer 530 have a refractive index, referred to as n, such as approximately 1.0003 for air, or in the range of 1.45-2.0 for glass (depending on the type of glass).

The first pitch P₁ and second pitch P₂ can be selected so that the line pattern is focused at a target plane a particular focal distance s away from the second grating 430. The difference between pitches P₁ and P₂ is related to the focal distance s by the following formula:

$${P}_{2} - {P}_{1} = \frac{{tP}_{2}}{s n} \qquad ( 1 )$$

The dual-pitch double grating is able to focus the line pattern in the near field, e.g., a focal distance s of 20 cm or less from the double grating. The first pitch P₁ and the second pitch P₂ may each be selected in the range of 1 μm to 200 μm. In some embodiments, the first pitch P₁ and the second pitch P₂ may each be selected in the range of 5 μm and 20 μm. The thickness of the transparent layer t may be in the range of 10 μm and 10 mm, e.g., between in the range of 0.2 mm and 2 mm.

### Example Line Pattern Generator with Double Grating and Focusing Lens

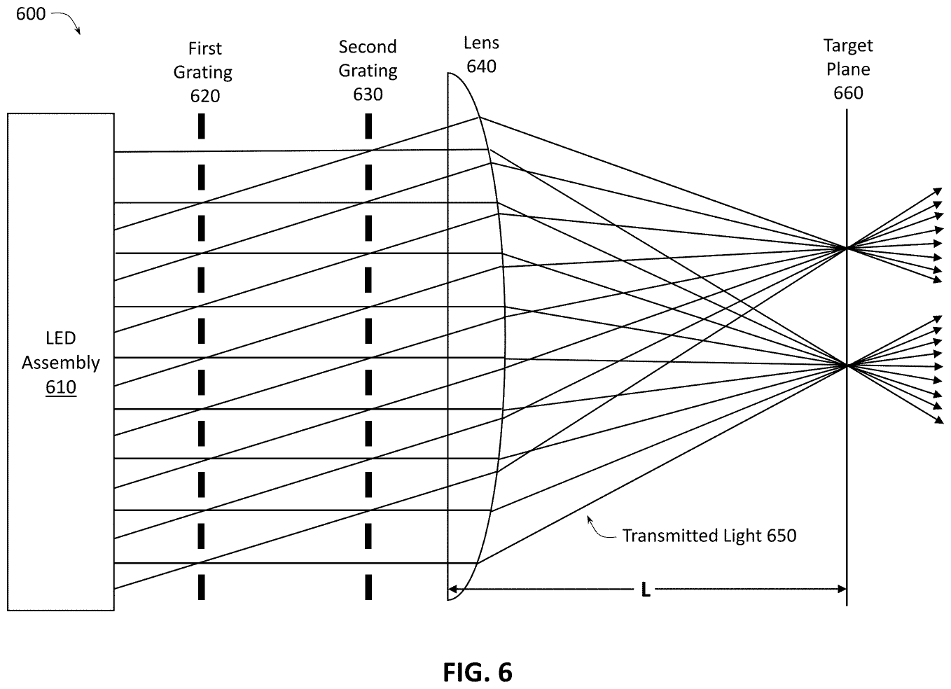

FIG. 6 provides a cross section of a line pattern generator 600 having a double grating with a lens for focusing light along a target plane, according to some embodiments of the present disclosure. The line pattern generator 600 includes an LED assembly 610, a first grating 620, a second grating 630, and a lens 640. The LED assembly 610 may be similar to the LED assembly 310 or LED assembly 410 described with respect to FIGS. 3 and 4. The LED assembly 610 may include a reflective element, such as the reflector 325 shown in FIG. 3. The first grating 620 and second grating 630 collectively form a double grating. The first grating 620 may be similar to the first grating 340 or first grating 420 described with respect to FIGS. 3 and 4, and the second grating 630 may be similar to the second grating 345 or second grating 430 described with respect to FIGS. 3 and 4. The first grating 620 and second grating 630 are on opposite sides of a transparent layer, which may be similar to the transparent layer 335 or 530 described above. Each of the first and second gratings 620 and 630 has alternating light blocking sections and light transmitting sections. As described with respect to FIG. 3, the light blocking sections of the gratings 620 and 630 may be configured to reflect light emitted from the LED assembly 610 towards a reflective element, which reflects at least a portion of this reflected light towards the double grating.

Unlike the gratings shown in FIGS. 3-5, the first grating 620 and second grating 630 shown in FIG. 6 have the same pitch. In other embodiments, the first grating 620 and the second grating 630 have unequal pitches, e.g., the pitch of the second grating 630 may be less than the pitch of the first grating 620.

The LED assembly 610 includes at least one LED that emits light directed at the double grating such that a first portion of the emitted light passes through the first grating 620, and a second portion of the light passed through the first grating passes through the second grating 630. The example rays of transmitted light 650 that passes from the LED assembly through the first grating 620 and the second grating 630 have similar paths to the example light paths shown in FIG. 1. Unlike the transmitted light 140 in FIG. 1, the transmitted light 650 in FIG. 6 also passes through a lens 640, which is a convergent lens configured to adjust the transmitted light 650 so that it has a different focal distance from the focal distance of the double grating alone, and converges at a target plane 660. The double grating may have a first focal distance, and the combination of the double grating and the lens 640 has a second focal distance that is less than the first focal distance. For example, the first focal distance of the double grating shown in FIG. 6 is an infinite distance away from the double grating. In other embodiments, the first focal distance of the double grating may be shorter, e.g., 100 cm, 50 cm, or 20 cm away from the double grating. The target plane 660 is at the second focal distance, labelled L in FIG. 6, from the lens 640. The transmitted light 650 forms a line pattern having alternating bright portions and dark portions. The lens 640 may be a plano-convex lens, as shown in FIG. 6, or another type of convergent lens, such as a biconvex lens, or series of multiple lenses that converge light.

FIG. 6 shows multiple paths of transmitted light 650 that pass through the first grating 620, the second grating 630, and the lens 640. The LED assembly 610 emits light at various angles, some of which are shown in FIG. 6. The lens 640 focuses the light that passes through the first grating 620 and the second grating 630 such that rays of the transmitted light 650 are focused at particular lines along the target plane 660. Cross sections of two such focal lines are shown in FIG. 6. The rays of transmitted light 650 shown in FIG. 6 overlap at two points in the cross section shown in FIG. 6. These points may be the maxima of the bright portions of the line pattern created by the line pattern generator 600. The rays of transmitted light 650 shown in FIG. 6 are a subset of the transmitted light paths. Examples of full line patterns are shown in FIGS. 7-10.

The line pattern generator 600 with the double grating and convergent lens is able to focus the line pattern in the near field, e.g., a focal distance L of 20 cm or less from the lens 640. The pitches of the first grating 620 and second grating 630 may be selected in the range of 1 μm to 200 μm. In some embodiments, the pitches of the first grating 620 and second grating 630 are each in the range of 5 μm and 20 μm. The thickness of a transparent layer between the first grating 620 and second grating 630 may be in the range of 10 μm and 10 mm, e.g., between in the range of 0.2 mm and 2 mm.

### Example Line Pattern Generator with Dual-Pitch Double Grating and a Focusing Lens

In some embodiments, a line pattern generator includes both a dual-pitch double grating, such as the double grating assembly described with respect to FIGS. 3-5, and a focusing lens, such as the lens 640 described with respect to FIG. 6. As described with respect to FIGS. 3-5, the dual-pitch double grating is configured to focus a line pattern at a particular focal distance from the double grating. Light that is transmitted through the double grating then passes through a lens, which alters the focal distance of the transmitted light. The line pattern generator with the convergent lens has a second focal distance that is different from the focal distance associated with the dual-pitch double grating. For example, if the dual-pitch double grating has a focal distance of 10 cm, a convergent lens can be added to the line pattern generator to change the focal distance to 5 cm. Alternatively, a divergent lens may be added to the line pattern generator to change the focal distance to 20 cm.

An adjustable line pattern generator can include a dual-pitch double grating and one or more removable lenses. The dual-pitch double grating has a default focal distance, and one or more lenses can be added or removed from the adjustable line pattern generator to adjust the focal distance. For example, an adjustable line pattern generator can have a default focal distance of 20 cm, and two removable lenses, each of which can be moved into the line of the transmitted light to create a focal distance of 15 cm or 10 cm.

### Example Simulation Results for Line Pattern Generators

FIG. 7A provides light intensity fields at several distances for a double grating line pattern generator focused 5 cm from the line pattern generator, according to some embodiments of the present disclosure. The light intensity fields 710-760 may be generated by a line pattern generator having a dual-pitch double grating and/or a focusing lens, e.g., any of the line pattern generators described with respect to FIGS. 3-6, or a line pattern generator having both a dual-pitch double grating and one or more focusing lenses. Each light intensity field 710-760 is a simulation of the light across an x-y plane at a different distance z from the line pattern generator. The x axis and y axis are labelled in millimeters.

The line pattern is most visible in the light intensity field 720, which is 5 cm from the line pattern generator, corresponding to the focal distance of the line pattern generator of 5 cm. The line pattern is somewhat visible in the light intensity field 730, which is 10 cm from the line pattern generator, but the alternating bright portions and dark portions are much less crisp than in light intensity field 720. In the other light intensity fields 710, 740, 750, and 760, the line pattern nearly vanishes.

FIG. 7B provides a close up of the light intensity field 720 a distance 5 cm from the double grating line pattern generator focused 5 cm from the line pattern generator, according to some embodiments of the present disclosure. The close up of the light intensity field 720 shows more clearly the alternating bright portions, such as bright portion 770, and dark portions, such as dark portion 780.

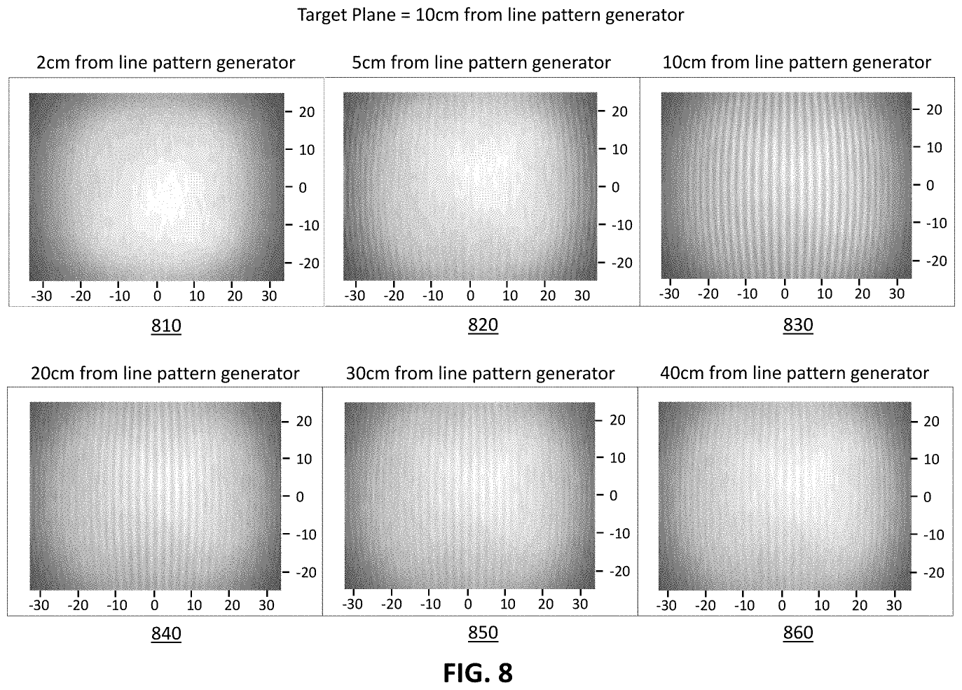

FIG. 8 provides light intensity fields at several distances for a double grating line pattern generator focused 10 cm from the line pattern generator, according to some embodiments of the present disclosure. The light intensity fields 810-860 may be generated by a line pattern generator having a dual-pitch double grating and/or a focusing lens, e.g., any of the line pattern generators described with respect to FIGS. 3-6, or a line pattern generator having both a dual-pitch double grating and one or more focusing lenses. Each light intensity field 810-860 is a simulation of the light across an x-y plane at a different distance z from the line pattern generator. The x axis and y axis are labelled in millimeters.

The line pattern is most visible in the light intensity field 730, which is 10 cm from the line pattern generator, corresponding to the focal distance of the line pattern generator of 10 cm. The line pattern is somewhat visible in the light intensity field 820, which is 5 cm from the line pattern generator, and vanishes in the light intensity field 810, which is 2 cm from the line pattern generator. In the other light intensity fields 840, 850, and 860, the line pattern is somewhat visible, but the alternating bright portions and dark portions are less crisp than in light intensity field 830.

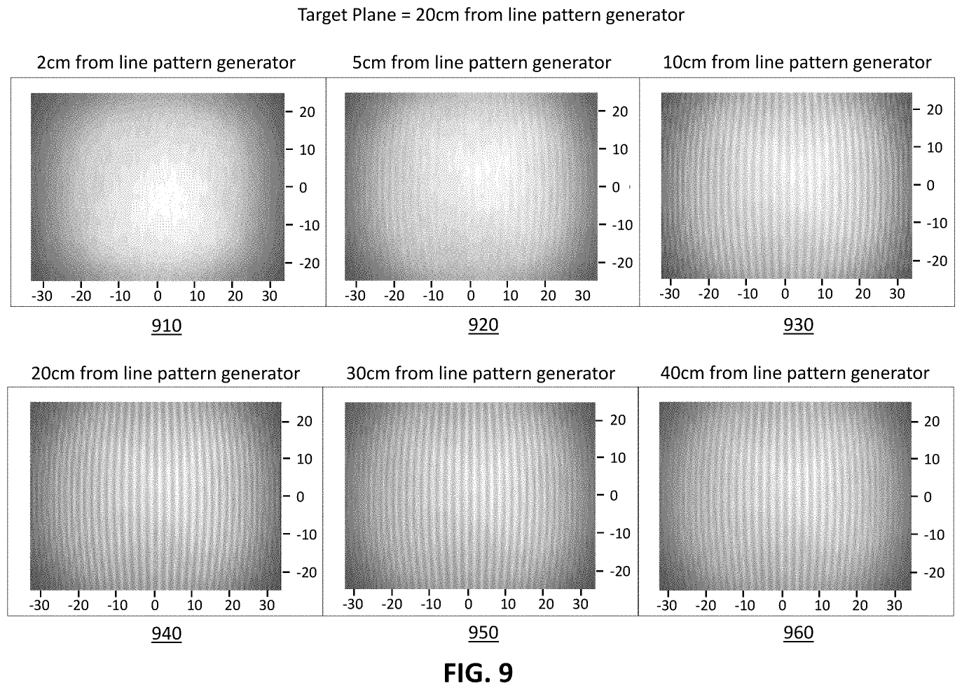

FIG. 9 provides light intensity fields at several distances for a double grating line pattern generator focused 20 cm from the line pattern generator, according to some embodiments of the present disclosure. The light intensity fields 910-960 may be generated by a line pattern generator having a dual-pitch double grating and/or a focusing lens, e.g., any of the line pattern generators described with respect to FIGS. 3-6, or a line pattern generator having both a dual-pitch double grating and one or more focusing lenses. Each light intensity field 910-960 is a simulation of the light across an x-y plane at a different distance z from the line pattern generator. The x axis and y axis are labelled in millimeters.

The line pattern is most visible in the light intensity field 940, which is 20 cm from the line pattern generator, corresponding to the focal distance of the line pattern generator of 20 cm. The line pattern is somewhat visible in the light intensity field 930, which is 10 cm from the line pattern generator, and vanishes in the light intensity fields 910 and 920, which are 2 cm and 5 cm from the line pattern generator, respectively. In the other light intensity fields 950 and 960, beyond the focal distance of 20 cm, the line pattern is also visible.

### Example Distance Measurement System

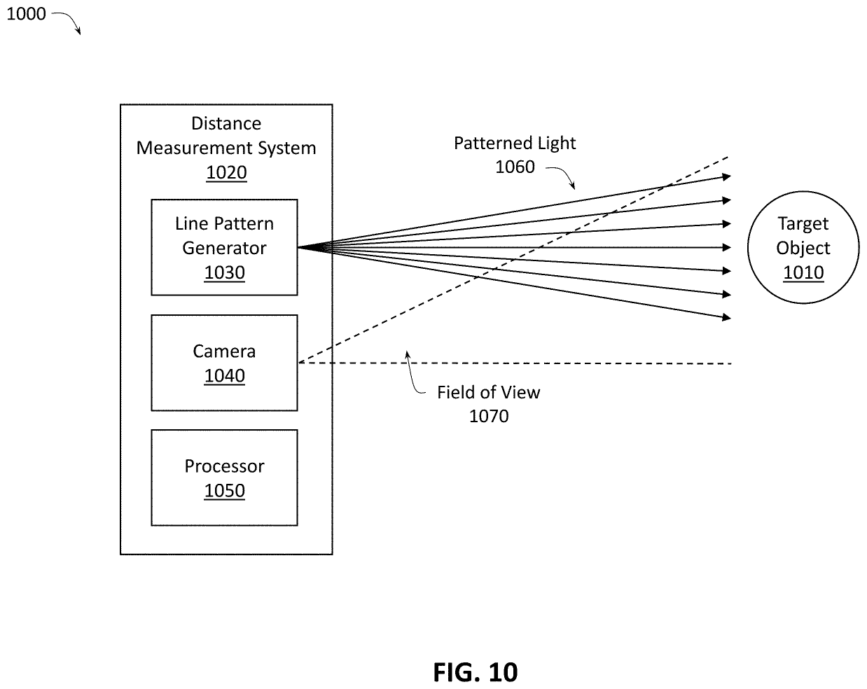

FIG. 10 provides a block diagram illustrating an example of a distance measurement system 1020 for measuring a distance to a target object 1010, according to some embodiments of the present disclosure. The distance measurement system 1020 is an example application of the near field line pattern generator described herein. The distance measurement system 1020 includes a line pattern generator 1030, a camera 1040, and a processor 1050. The line pattern generator 1030 produces patterned light 1060. The patterned light 1060 may be focused at a target plane in the near field, e.g., at a focal distance 20 cm or less from the distance measurement system 1020. The line pattern generator 1030 may have a dual-pitch double grating and/or a focusing lens, e.g., any of the line pattern generators described with respect to FIGS. 3-6, or a line pattern generator having both a dual-pitch double grating and one or more focusing lenses. As shown in FIG. 10, the line pattern generator 1030 emits the patterned light 1060 in the direction of a target object 1010.

The camera 1040 is configured to capture one or more images of a field of view 1070 of the camera 1040. The camera 1040 is positioned to capture a field of view 1070 that includes some or all of the patterned light 1060 when the patterned light 1060 is incident on one or more target objects 1010 within a given region relative to the distance measurement system 1020. In the example shown in FIG. 10, the camera 1040 is positioned to capture images of the target object 1010, which is patterned by the patterned light 1060. The camera 1040 is configured to capture the wavelength(s) of light emitted by the line pattern generator 1030. For example, if the patterned light 1060 is near infrared light, the camera 1040 captures light in the near infrared range. In some embodiments, the line pattern generator 1030 and the camera 1040 are two separate devices. In some embodiments, multiple cameras 1040 are included, e.g., to take images of the target object 1010 from different angles.

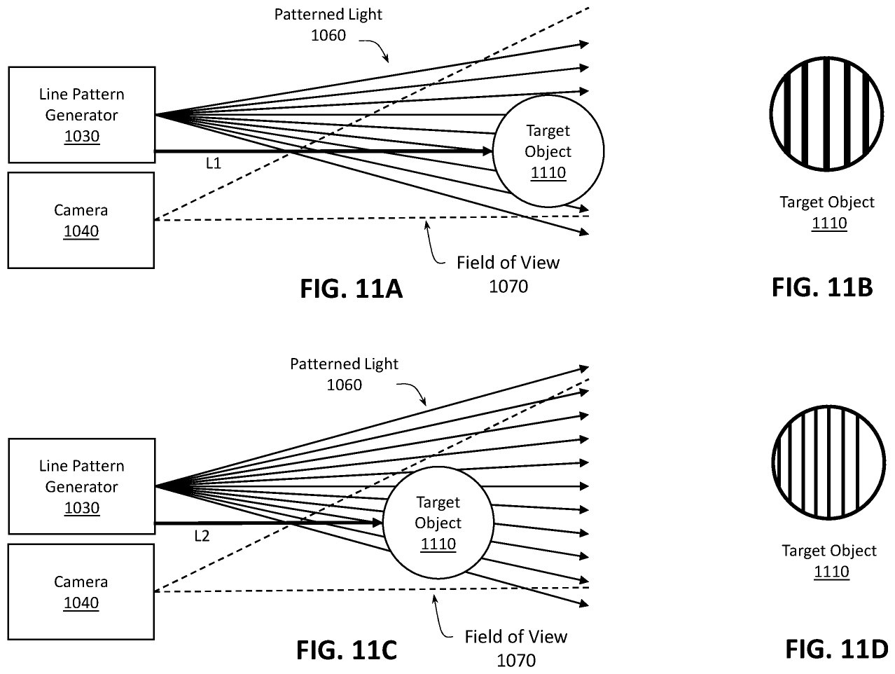

The processor 1050 receives one or more images captured by the camera 1040 and analyzes the image(s). In the example shown in FIG. 10, the processor 1050 may determine a distance of the target object 1010 based on at least one image of the patterned light 1060 projected on the target object 1010. The appearance of the patterned light 1060 on the target object 1010 varies based on the distance between the line pattern generator 1030 and the target object 1010. For example, the processor may determine the distance to the target object 1010 based on the distance between lines (e.g., sequential bright sections and/or sequential dark sections) in the patterned light 1060, or based on a position of the lines in the patterned light 1060. In some embodiments, the processor 1050 is configured to determine additional or alternative information about the target object 1010 based on the image(s), such as orientation, position, or size. An example of how the line pattern on a target object can vary based on the distance to the target object is shown in FIGS. 11A-11D. In some embodiments, the processor 1050 is incorporated in a different device from the line pattern generator 1030 and/or the camera 1040.

FIG. 11A provides an example of the line pattern generator of FIG. 10 generating a line pattern on a target object at a first distance from the line pattern generator, according to some embodiments of the present disclosure. In this example, an example target object 1110 is a distance L1 from the line pattern generator 1030. The target object 1110 in this example has a spherical shape. The view shown in FIG. 11A is a top view of the target object 1110 and the patterned light 1060, and the patterned light produces a pattern of alternating light and dark vertical lines. The rays of patterned light 1060 shown in FIG. 11A represent maxima of the bright portions of the line pattern created by the line pattern generator 1030.

FIG. 11B provides an example of the line pattern generated on the target object 1110 in FIG. 11A, according to some embodiments of the present disclosure. The target object 1110 shown in FIG. 11B is a front view of target object 1110 taken from the point of view of the camera 1040. As shown in FIG. 11B, the line pattern generator 1030 projected five vertical lines across the target object 1110.

FIG. 11C provides an example of the line pattern generator of FIG. 10 generating a line pattern on a target object at a second distance from the line pattern generator, according to some embodiments of the present disclosure. In this example, the example target object 1110 is a distance L2 from the line pattern generator 1030, where L2 is less than L1. In other words, the target object 1110 has moved closer to the line pattern generator 1030 from its previous position in FIG. 11A.

FIG. 11D provides an example of the line pattern generated on the target object in FIG. 11C, according to some embodiments of the present disclosure. Compared to FIG. 11B, FIG. 11D shows seven vertical lines projected across the target object 1110 (rather than five), and the projected lines appear narrower and closer together. In addition, a portion of the target object 1110 does not have any lines projected on it; this portion may be outside the reach of the line patterned generator 1030. The processor 1050 can analyze the features of the lines (e.g., the width of the lines, the number of lines across a target object) to determine position information about the target object 1110, e.g., the distance to the target object 1110.

As demonstrated in the light intensity fields in FIGS. 7A-9, the visibility of the line pattern also varies based on the focal distance and the distance from the line pattern generator. In some embodiments, the processor 1050 may analyze the visibility or blurriness of the line pattern on a target object to determine the distance to the target object.

In some embodiments, the processor 1050 stores calibration information for the target object 1010 and uses this information to determine the distance of the target object 1010. For example, the distance measurement system 1020 uses the camera 1040 to collect images of the target object 1010 illuminated by the patterned light 1060 at known distances. The calibration information may include, for example, a distance between lines in the patterned light 1060 when projected on the target object 1010 at one or more distances, or positions of lines in the patterned light 1060 when projected on the target object 1010 at one or more known distances.

### Example Data Processing System

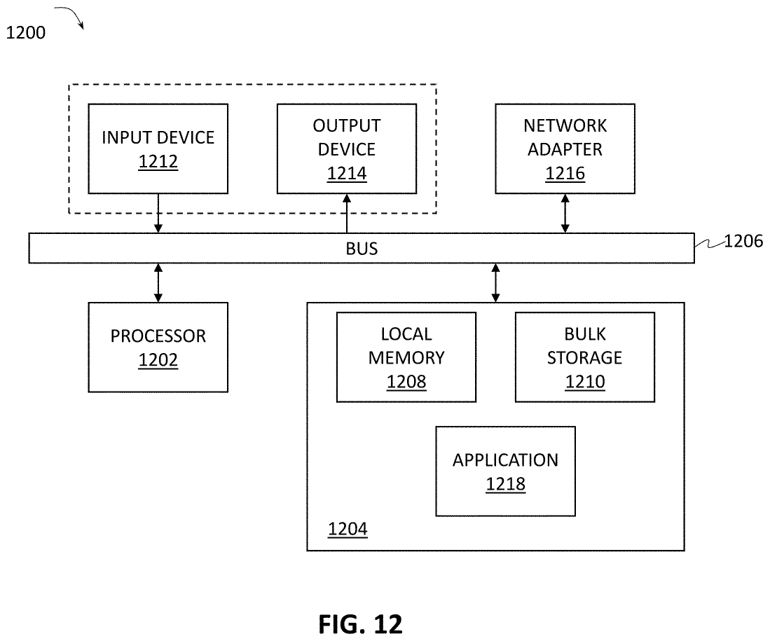

FIG. 12 provides a block diagram illustrating an example data processing system 1200 that may be configured to implement at least portions of distance measurement systems with near field line pattern generators as described herein, e.g., of the distance measuring systems as described with reference to FIGS. 10-11D, according to some embodiments of the present disclosure.

As shown in FIG. 12, the data processing system 1200 may include at least one processor 1202, e.g. a hardware processor 1202, coupled to memory elements 1204 through a system bus 1206. As such, the data processing system may store program code within memory elements 1204. Further, the processor 1202 may execute the program code accessed from the memory elements 1204 via a system bus 1206. In one aspect, the data processing system may be implemented as a computer that is suitable for storing and/or executing program code. It should be appreciated, however, that the data processing system 1200 may be implemented in the form of any system including a processor and a memory that is capable of performing the functions described within this disclosure.

In some embodiments, the processor 1202 can execute software or an algorithm to perform the activities as discussed in this specification, in particular activities related to measuring distances, such as various techniques implemented by the distance measurement systems described herein. The processor 1202 may include any combination of hardware, software, or firmware providing programmable logic, including by way of non-limiting example a microprocessor, a DSP, a field-programmable gate array (FPGA), a programmable logic array (PLA), an integrated circuit (IC), an application specific IC (ASIC), or a virtual machine processor. The processor 1202 may be communicatively coupled to the memory element 1204, for example in a direct-memory access (DMA) configuration, so that the processor 1202 may read from or write to the memory elements 1204.

In general, the memory elements 1204 may include any suitable volatile or non-volatile memory technology, including double data rate (DDR) random access memory (RAM), synchronous RAM (SRAM), dynamic RAM (DRAM), flash, read-only memory (ROM), optical media, virtual memory regions, magnetic or tape memory, or any other suitable technology. Unless specified otherwise, any of the memory elements discussed herein should be construed as being encompassed within the broad term “memory.” The information being measured, processed, tracked or sent to or from any of the components of the data processing system 1200 could be provided in any database, register, control list, cache, or storage structure, all of which can be referenced at any suitable timeframe. Any such storage options may be included within the broad term “memory” as used herein. Similarly, any of the potential processing elements, modules, and machines described herein should be construed as being encompassed within the broad term “processor.” The distance measurement system 1020 shown in FIG. 10 can also include suitable interfaces for receiving, transmitting, and/or otherwise communicating data or information in a network environment so that they can communicate with external data processing systems.

In certain example implementations, mechanisms for implementing distance measurement systems s as outlined herein may be implemented by logic encoded in one or more tangible media, which may be inclusive of non-transitory media, e.g., embedded logic provided in an ASIC, in DSP instructions, software (potentially inclusive of object code and source code) to be executed by a processor, or other similar machine, etc. In some of these instances, memory elements, such as e.g. the memory elements 1204 shown in FIG. 12, can store data or information used for the operations described herein. This includes the memory elements being able to store software, logic, code, or processor instructions that are executed to carry out the activities described herein. A processor can execute any type of instructions associated with the data or information to achieve the operations detailed herein. In one example, the processors, such as e.g. the processor 1202 shown in FIG. 12, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., an FPGA, a DSP, an erasable programmable read-only memory (EPROM), an electrically erasable programmable read-only memory (EEPROM)) or an ASIC that includes digital logic, software, code, electronic instructions, or any suitable combination thereof.

The memory elements 1204 may include one or more physical memory devices such as, for example, local memory 1208 and one or more bulk storage devices 1210. The local memory may refer to RAM or other non-persistent memory device(s) generally used during actual execution of the program code. A bulk storage device may be implemented as a hard drive or other persistent data storage device. The processing system 1200 may also include one or more cache memories (not shown) that provide temporary storage of at least some program code in order to reduce the number of times program code must be retrieved from the bulk storage device 1210 during execution.

As shown in FIG. 12, the memory elements 1204 may store an application 1218. In various embodiments, the application 1218 may be stored in the local memory 1208, the one or more bulk storage devices 1210, or apart from the local memory and the bulk storage devices. It should be appreciated that the data processing system 1200 may further execute an operating system (not shown in FIG. 12) that can facilitate execution of the application 1218. The application 1218, being implemented in the form of executable program code, can be executed by the data processing system 1200, e.g., by the processor 1202. Responsive to executing the application, the data processing system 1200 may be configured to perform one or more operations or method steps described herein.

Input/output (I/O) devices depicted as an input device 1212 and an output device 1214, optionally, can be coupled to the data processing system. Examples of input devices may include, but are not limited to, a keyboard, a pointing device such as a mouse, or the like. Examples of output devices may include, but are not limited to, a monitor or a display, speakers, or the like. In some embodiments, the output device 1214 may be any type of screen display, such as plasma display, liquid crystal display (LCD), organic light emitting diode (OLED) display, electroluminescent (EL) display, or any other indicator, such as a dial, barometer, or light emitting diode (LED). In some implementations, the system may include a driver (not shown) for the output device 1214. Input and/or output devices 1212, 1214 may be coupled to the data processing system either directly or through intervening I/O controllers.

In an embodiment, the input and the output devices may be implemented as a combined input/output device (illustrated in FIG. 12 with a dashed line surrounding the input device 1212 and the output device 1214). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 1216 may also, optionally, be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 1200, and a data transmitter for transmitting data from the data processing system 1200 to said systems, devices and/or networks. Modems, cable modems, and Ethernet cards are examples of different types of network adapter that may be used with the data processing system 1200.

### Select Examples

Example 1 provides an apparatus configured to generate a line pattern, the apparatus including a (1) double grating assembly comprising a first grating and a second grating, the first grating including alternating light blocking sections and light transmitting sections arranged at a first pitch, the second grating comprising alternating light blocking sections and light transmitting sections arranged at a second pitch, the second pitch less than the first pitch; and (2) at least one light emitting diode (LED) positioned to emit light directed at the double grating assembly such that a first portion of the emitted light passes through the first grating, and a second portion of the light passed through the first grating passes through the second grating, the second portion of light forming a line pattern at a focal distance from the double grating assembly, the line pattern having alternating bright portions and dark portions.

Example 2 provides the apparatus according to example 1, where a difference between the first pitch and the second pitch, referred to as P₁−P₂, is equal to tP₂/(sn), wherein P₁ is the first pitch, P₂ is the second pitch, t is a distance between the first grating and the second grating, s is the focal distance from the double grating assembly, and n is a refractive index of a material between the first grating and the second grating.

Example 3 provides the apparatus according to any one of the preceding examples, where the apparatus further includes a reflective element, wherein the light blocking sections of the first grating and the second grating are configured to reflect a third portion of the light emitted from the LED towards the reflective element, and the reflective element is configured to reflect the portion of reflected light towards the double grating assembly.

Example 4 provides the apparatus according to any one of the preceding examples, where the focal distance is 20 centimeters or less.

Example 5 provides the apparatus according to any one of the preceding examples, where the first pitch is between about 1 μm and 200 μm, e.g., between about 5 μm and 20 μm, and the second pitch is between about 1 μm and 200 μm, e.g., between about 5 μm and 20 μm.

Example 6 provides the apparatus according to any one of the preceding examples, where the first grating and the second grating are deposited on opposite surfaces of a transparent layer.

Example 7 provides the apparatus according to example 6, where a thickness of the transparent layer is between about 10 μm and 10 mm, e.g., between about 0.2 mm and 2 mm.

Example 8 provides the apparatus according to any one of the preceding examples, where the focal distance is associated with the double grating assembly, and the apparatus further includes a convergent lens disposed between the double grating assembly and the focal distance of the double grating assembly, the convergent lens configured to alter a focal distance of light passed through the double grating assembly such that the apparatus comprising the convergent lens has a second focal distance different from the focal distance associated with the double grating assembly.

Example 9 provides an apparatus configured to generate a line pattern, the apparatus including a double grating assembly comprising a first grating and a second grating, the first grating comprising alternating light blocking sections and light transmitting sections arranged at a first pitch, the second grating comprising alternating light blocking sections and light transmitting sections arranged at a second pitch, the double grating assembly having a first focal distance; at least one light emitting diode (LED) positioned to emit light directed at the double grating assembly such that a first portion of the emitted light passes through the first grating, and a second portion of the light passed through the first grating passes through the second grating; and a convergent lens configured to adjust the light passed through the second grating such that light passing through the convergent lens forms a line pattern at a second focal distance from the double grating assembly, the line pattern having alternating bright portions and dark portions.

Example 10 provides the apparatus according to example 9, where the second focal distance is less than the first focal distance.

Example 11 provides the apparatus according to either of examples 9 or 10, where the first pitch is equal to the second pitch.

Example 12 provides the apparatus according to either of examples 9 or 10, where the second pitch is less than the first pitch.

Example 13 provides the apparatus according to any of examples 9 through 12, where the second focal distance is 20 centimeters or less.

Example 14 provides the apparatus according to any of examples 9 through 13, where the apparatus further includes a reflective element, and the light blocking sections of the first grating and the second grating are configured to reflect a third portion of the light emitted from the LED towards a reflective element, and the reflective element is configured to reflect the portion of reflected light towards the double grating assembly.

Example 15 provides the apparatus according to any of examples 9 through 14, where the first pitch is between about 1 μm and 200 μm, e.g., between about 5 μm and 20 μm, and the second pitch is between about 1 μm and 200 μm, e.g., between about 5 μm and 20 μm.

Example 16 provides the apparatus according to any of examples 9 through 15, where the first grating and the second grating are deposited on opposite surfaces of a transparent layer.

Example 17 provides the apparatus according to example 16, where a thickness of the transparent layer is between about 10 μm and 10 mm, e.g., between about 0.2 mm and 2 mm.

Example 18 provides system for measuring distance, the system including (1) a line pattern generator configured to project a line pattern on a target object, the line pattern generator comprising: (a) at least one light emitting diode (LED) configured to emit light; and (b) a double grating comprising a first grating and a second grating, each of the first grating and the second grating comprising a plurality of alternating light blocking sections and light transmitting sections, wherein a pitch of the first grating is less than a pitch of the second grating, the double grating and the at least one LED arranged such that a portion of the light emitted from the at least one LED passes through the first grating and the second grating and forms a line pattern at a focal distance from the double grating, the line pattern having alternating bright portions and dark portions; and (2) a processor configured to determine a distance of the target object based on at least one image of the line pattern projected on the target object.

Example 19 provides the system according to example 18, where the processor is configured to determine the distance of the target object based on at least one of a distance between lines in the line pattern projected on the target object and a position of lines in the line pattern projected on the target object.

Example 20 provides the system according to either example 18 or 19, where the processor is configured to store a calibration for the target object, the calibration including at least one of a distance between lines in the line pattern projected on the target object and a position of lines in the line pattern projected on the target object at a known distance.

Example 21 provides the system according to any of examples 18 through 20, where the system further includes camera configured to capture the at least one image of the line pattern projected on the target object.

Example 22 provides the system according to any of examples 18 through 21, where a difference between the pitch of the first grating and the pitch of the second grating referred to as P₁−P₂, is equal to tP₂/(sn), where P₁ is the pitch of the first grating, P₂ is the pitch of the second grating, t is a distance between the first grating and the second grating, s is the focal distance from the double grating, and n is a refractive index of a material between the first grating and the second grating.

Example 23 provides the system according to any of examples 18 through 22, where the line pattern generator further includes a reflective element, and the light blocking sections of the first grating and the second grating are configured to reflect a second portion of the light emitted from the LED towards a reflective element, and the reflective element is configured to reflect the second portion of light towards the double grating.

Example 24 provides the system according to any of examples 18 through 23, where the focal distance is 20 centimeters or less.

Example 25 provides the system according to any of examples 18 through 24, where the pitch of the first grating is between about 1 μm and 200 μm, e.g., between about 5 μm and 20 μm, and the pitch of the second grating is between about 1 μm and 200 μm, e.g., between about 5 μm and 20 μm.

Example 26 provides the system according to any of examples 18 through 25, where the first grating and the second grating are deposited on opposite surfaces of a transparent layer,

Example 27 provides the system according to example 26, where a thickness of the transparent layer is between about 10 μm and 10 mm, e.g., between about 0.2 mm and 2 mm.

Example 28 provides the system according to any of examples 18 through 27, where the focal distance is associated with the double grating, and the line pattern generator further includes a convergent lens disposed between the double grating and the focal distance of the double grating, the convergent lens configured to alter a focal distance of light passed through the double grating such that the line pattern generator comprising the convergent lens has a second focal distance different from the focal distance associated with the double grating.

Example 29 provides system for measuring distance, the system including (1) a line pattern generator configured to project a line pattern on a target object, the line pattern generator comprising: (a) at least one light emitting diode (LED) configured to emit light; (b) a double grating comprising a first grating and a second grating, each of the first grating and the second grating comprising a plurality of alternating light blocking sections and light transmitting sections, the double grating and the at least one LED arranged such that a portion of the light emitted from the at least one LED passes through the first grating and the second grating and forms a line pattern at a first focal distance from the double grating; and (c) a convergent lens configured to adjust the first focal distance of the light passed through the first grating and the second grating, where light passing through the convergent lens forms a line pattern at a second focal distance from the double grating, the line pattern having alternating bright portions and dark portions; and (2) a processor configured to determine a distance of the target object based on at least one image of the line pattern projected on the target object.

Example 30 provides the system according to example 29, where the processor is configured to determine the distance of the target object based on at least one of a distance between lines in the line pattern projected on the target object and a position of lines in the line pattern projected on the target object.

Example 31 provides the system according to either example 29 or 30, where the processor is configured to store a calibration for the target object, the calibration including at least one of a distance between lines in the line pattern projected on the target object and a position of lines in the line pattern projected on the target object at a known distance.

Example 32 provides the system according to any of examples 29 through 31, where the system further includes camera configured to capture the at least one image of the line pattern projected on the target object.

Example 33 provides the system according to any of examples 29 through 32, where the second focal distance is less than the first focal distance.

Example 34 provides the system according to any of examples 29 through 33, where a pitch of the first grating is equal to a pitch of the second grating.

Example 35 provides the system according to any of examples 29 through 33, where a pitch of the second grating is less than a pitch of the first grating.

Example 36 provides the system according to any of examples 29 through 35, where the second focal distance is 20 centimeters or less.

Example 37 provides the system according to any of examples 29 through 36, where the line pattern generator further includes a reflective element, and the light blocking sections of the first grating and the second grating are configured to reflect a third portion of the light emitted from the LED towards a reflective element, and the reflective element is configured to reflect the portion of reflected light towards the double grating.

Example 38 provides the system according to any of examples 29 through 37, where a pitch of the first grating is between about 1 μm and 200 μm, e.g., between about 5 μm and 20 μm, and a pitch of the second grating is between about 1 μm and 200 μm, e.g., between about 5 μm and 20 μm.

Example 39 provides the system according to any of examples 29 through 38, where the first grating and the second grating are deposited on opposite surfaces of a transparent layer.

Example 40 provides the system according to example 39, where a thickness of the transparent layer is between about 10 μm and 10 mm, e.g., between about 0.2 mm and 2 mm.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

It should be appreciated that the electrical circuits of the accompanying drawings and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

In some embodiments, any number of electrical circuits of the accompanying drawings may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer readable storage medium comprising instructions to allow a processor to carry out those functionalities.

In some embodiments, the electrical circuits of the accompanying drawings may be implemented as stand-alone modules (e.g., a device with associated components and circuitry configured to perform a specific application or function) or implemented as plug-in modules into application specific hardware of electronic devices. Note that some embodiments of the present disclosure may be readily included in a system on chip (SOC) package, either in part, or in whole. An SOC represents an integrated circuit (IC) that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the near field line pattern generator may be implemented in one or more silicon cores in Application Specific Integrated Circuits (ASICs), Field Programmable Gate Arrays (FPGAs), and other semiconductor chips.

It is also important to note that the functions related to the near field line pattern generator, e.g., those summarized in the one or more processes shown in FIGS. 3-12, illustrate only some of the possible functions that may be executed by, or within, the distance measuring system. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of any of the devices and systems described herein may also be implemented with respect to the methods or processes described herein and specifics in the examples may be used anywhere in one or more embodiments.

1. An apparatus configured to generate a line pattern, the apparatus comprising:
a double grating assembly comprising a first grating and a second grating, the first grating comprising alternating light blocking sections and light transmitting sections arranged at a first pitch, the second grating comprising alternating light blocking sections and light transmitting sections arranged at a second pitch, the second pitch less than the first pitch; and
at least one light emitting diode (LED) positioned to emit light directed at the double grating assembly such that a first portion of the emitted light passes through the first grating, and a second portion of the light passed through the first grating passes through the second grating, the second portion of light forming a line pattern at a focal distance from the double grating assembly, the line pattern having alternating bright portions and dark portions.

2. The apparatus of claim 1, wherein a difference between the first pitch and the second pitch, referred to as P₁−P₂, is equal to tP₂/(sn), wherein P₁ is the first pitch, P₂ is the second pitch, t is a distance between the first grating and the second grating, s is the focal distance from the double grating assembly, and n is a refractive index of a material between the first grating and the second grating.

3. The apparatus of claim 1 further comprising a reflective element, wherein the light blocking sections of the first grating and the second grating are configured to reflect a third portion of the light emitted from the LED towards the reflective element, and the reflective element is configured to reflect the portion of reflected light towards the double grating assembly.

4. The apparatus of claim 1, wherein the focal distance is 20 centimeters or less.

5. The apparatus of claim 1, wherein the first pitch is between about 1 μm and 200 μm, e.g., between about 5 μm and 20 μm, and the second pitch is between about 1 μm and 200 μm, e.g., between about 5 μm and 20 μm.

6. The apparatus of claim 1, wherein the first grating and the second grating are deposited on opposite surfaces of a transparent layer having a thickness between about 10 μm and 10 mm, e.g., between about 0.2 mm and 2 mm.

7. The apparatus of claim 1, wherein the focal distance is associated with the double grating assembly, the apparatus further comprising a convergent lens disposed between the double grating assembly and the focal distance of the double grating assembly, the convergent lens configured to alter a focal distance of light passed through the double grating assembly such that the apparatus comprising the convergent lens has a second focal distance different from the focal distance associated with the double grating assembly.

8. An apparatus configured to generate a line pattern, the apparatus comprising:
a double grating assembly comprising a first grating and a second grating, the first grating comprising alternating light blocking sections and light transmitting sections arranged at a first pitch, the second grating comprising alternating light blocking sections and light transmitting sections arranged at a second pitch, the double grating assembly having a first focal distance;
at least one light emitting diode (LED) positioned to emit light directed at the double grating assembly such that a first portion of the emitted light passes through the first grating, and a second portion of the light passed through the first grating passes through the second grating; and
a convergent lens configured to adjust the light passed through the double grating assembly such that light passing through the convergent lens forms a line pattern at a second focal distance, the line pattern having alternating bright portions and dark portions.

9. The apparatus of claim 8, wherein the second focal distance is less than the first focal distance.

10. The apparatus of claim 8, wherein the first pitch is equal to the second pitch.

11. The apparatus of claim 8, wherein the second pitch is less than the first pitch.

12. The apparatus of claim 8, wherein the second focal distance is 20 centimeters or less.

13. The apparatus of claim 8, further comprising a reflective element, wherein the light blocking sections of the first grating and the second grating are configured to reflect a third portion of the light emitted from the LED towards the reflective element, and the reflective element is configured to reflect the portion of reflected light towards the double grating assembly.

14. The apparatus of claim 8, wherein the first pitch is between about 1 μm and 200 μm, e.g., between about 5 μm and 20 μm, and the second pitch is between about 1 μm and 200 μm, e.g., between about 5 μm and 20 μm.

15. The apparatus of claim 8, wherein the first grating and the second grating are deposited on opposite surfaces of a transparent layer, and a thickness of the transparent layer is between about 10 μm and 10 mm, e.g., between about 0.2 mm and 2 mm.

16. A system for measuring distance, the system comprising:
a line pattern generator configured to project a line pattern on a target object, the line pattern generator comprising:
at least one light emitting diode (LED) configured to emit light; and
a double grating comprising a first grating and a second grating, each of the first grating and the second grating comprising a plurality of alternating light blocking sections and light transmitting sections, wherein a pitch of the first grating is less than a pitch of the second grating,
the double grating and the at least one LED arranged such that a portion of the light emitted from the at least one LED passes through the first grating and the second grating and forms a line pattern at a focal distance from the double grating, the line pattern having alternating bright portions and dark portions; and
a processor configured to determine a distance of the target object based on at least one image of the line pattern projected on the target object.

17. The system of claim 16, wherein the processor is configured to determine the distance of the target object based on at least one of a distance between lines in the line pattern projected on the target object and a position of lines in the line pattern projected on the target object.

18. The system of claim 16, wherein the processor is configured to store a calibration for the target object, the calibration comprising at least one of a distance between lines in the line pattern projected on the target object and a position of lines in the line pattern projected on the target object at a known distance.

19. The system of claim 16, wherein a difference between the pitch of the first grating and the pitch of the second grating referred to as P₁−P₂, is equal to tP₂/(sn), wherein P₁ is the pitch of the first grating, P₂ is the pitch of the second grating, t is a distance between the first grating and the second grating, s is the focal distance from the double grating, and n is a refractive index of a material between the first grating and the second grating.

20. The system of claim 16, wherein the focal distance is 20 centimeters or less, the pitch of the first grating is between about 1 μm and 200 μm, e.g., between about 5 μm and 20 μm, and the pitch of the second grating is between about 1 μm and 200 μm, e.g., between about 5 μm and 20 μm.
